(19) United States
(12) Patent Application Publication
(10) Pub. No.: US 2024/0311384 A1
(43) Pub. Date: Sep. 19, 2024

(54) METHODS, APPARATUS, AND SYSTEMS FOR PROVIDING A CHAMPION PEER JOURNEY RECOMMENDATION AND A VALUE TRACKING SYSTEM TO A QUERYING USER

(71) Applicant: Gartner, Inc., Stamford, CT (US)

(72) Inventors: Priya Goel, Palwal (IN); Shankar Kumar, Thane West (IN); Upender Phogat, Gurgaon (IN); Mukur Gupta, Jaipur (IN); Satyashiba Mohanty, Rourkela (IN)

(21) Appl. No.: 18/184,877

(22) Filed: Mar. 16, 2023

(51) Int. Cl. G06F 16/2457

(52) U.S. Cl. CPC G06F 16/24578

(57) ABSTRACT

Systems, apparatus, and methods are provided that identify a querying user's top peers, recommends an optimal product interaction journey, and tracks the value delivered. Peers of the querying user are identified based on the common profile attributes, product interaction, and similar user initiatives. A champion peer is recommended by sorting the peers based on the cumulative quality of product interactions which is modeled by a learnable parametric equation. A metric is formulated by measuring the value delivered to the user by computing the number of product interactions aligning to the user's initiative. Most engaging product interactions (e.g., documents read, events attended) by the champion peer aligning to querying user's initiatives are identified and are recommended to the querying user as a product interaction journey.

### BACKGROUND OF THE INVENTION

The present invention relates to the field of identifying peers and recommending a journey to a user that identifies documents and events consumed by a champion peer chosen from the identified peers. In addition, the invention provides a value tracking system for measuring value received by querying user by consuming recommended products.

Various tools for identifying peers are known in the art. For example, U.S. Pat. No. 8,661,034 to Polonsky et al. discloses methods and systems to recommend items and peers to the querying user using clustering and collaborative filtering algorithms. This patent proposes a peer recommendation algorithm that locates other users in a database who either have verified expertise for the keyword(s) provided by the querying user or have a profile match with the keyword(s) or the querying user's profile. These peers are then sorted based on how well they match the querying user.

U.S. Pat. No. 10,600,011 to Polonsky et al. discloses forming peer groups of the users with matching passive profiles and qualifying a few users from the group as experts based on the intra-peer group interactions and the extent of overlap with other passive profiles from the same peer group.

U.S. Pat. No. 8,244,674 to Davis et al. discloses methods and systems to locate peers for the querying user by sorting the candidate peers in the database based on the composite weights obtained from matching profile attributes such as the same initiative, product, vendor, operating system, industry, and firm size.

In addition, U.S. Pat. No. 10,817,518 to Polonsky et al. uses implicit profiles to recommend matching peers and route questions in a peer forum system. For finding the matching peers, the explicit user profile is appended with the keywords obtained from the implicit profile derived from the user's past behavior and interaction with items representing the user's interests, expertise, and skills.

The prior art systems such as the ones referenced above mostly rely on explicit profile information entered by the users and the keywords derived from the implicit profiles to locate the relevant peers. Such methods often result in recommending too many peers, all of whom might not be relevant and potentially missing out on the peer candidates who might be having similar product interaction journeys as the querying user but might not have a direct profile and/or keyword overlap. Another limitation of the prior art that the present invention addresses is that the products recommended by most of the prior art recommendation systems are unordered and do not consider the maturity of the user on their user initiative.

The present invention provides a champion peer recommendation system for locating a set of peer candidates which considers the explicit profile, user initiative, and the user-product interactions and sorts peer candidates based on peers' cumulative product interaction quality index to recommend a top champion peer for the querying user. Instead of making unordered product recommendations, the champion peer's most engaging product interactions that align with the querying user's initiatives are identified and are then presented in a form of a timeline showing different phases of maturity level on the user initiative.

Various product recommendation algorithms have been devised but the prior art does not offer any quantifiable metrics to measure and track the total amount of value received by the user by interacting with the recommended products. In addition to champion peer and product journey recommendations, the present invention also presents a quantifiable metric to measure the value received by a user in their interest areas by interacting with the aligning products.

The methods and apparatus of the present invention provide the foregoing and other advantages.

### SUMMARY OF THE INVENTION

The present invention relates to the field of identifying peers and recommending a journey to a user that identifies documents and events consumed by a champion peer chosen from the identified peers. In addition, the invention provides a value tracking system for measuring value received by querying user by consuming recommended products.

In one example embodiment of the present invention, a computerized method for providing a champion peer journey recommendation to a querying user is provided. The method may comprise providing a database comprising a listing of users and corresponding explicit profile information and implicit profile information for each of the users. The explicit profile information may comprise information input by or on behalf of the user and the implicit profile information may comprise information obtained from the user's product interactions. The method may further comprise determining one or more user initiatives for each user based on at least one of the explicit profile and the implicit profile of the corresponding user. Peer connections for a querying user can then be determined from among the users based on comparisons of the explicit profiles, the implicit profiles, and the user initiatives of the users and of the querying user. The users for which peer connections have been determined can then be ranked. A champion peer may then be determined which comprises a peer connected user having a highest ranking. A product interaction journey for the querying user may then be provided based upon identified products consumed by the champion peer that align with the one or more user initiatives of the querying user. The product interaction journey comprising a timeline for the querying user to consume the identified products.

The information input by the user forming the explicit profile may comprise at least one of industry type, user job role, country, enterprise size, and the like. The information obtained from the user's product interactions forming the implicit profile may comprise information obtained from documents read by the user and from events attended by the user.

The determining of the peer connections for the querying user may comprise determining profile matches between the users and the querying user. A profile match may be determined if at least one of the industry type, the user job role, the country, and one or more products consumed of one of the users is the same as that of the querying user or if the similarity between the vectorized representations of the user initiatives is greater than a threshold.

The database may be part of a computerized system that provides access to the products and enables tracking of the product interactions.

The ranking of the users for which peer connections have been determined may be based on one or more of a number of types of products interacted with, a cumulative product interaction quality index, a Boolean user retention flag, and a Boolean product interaction flag indicating whether a peer's total product interactions align with the querying user's initiative. The Boolean user retention flag may be based on whether the user was: (1) a new user in the system or a user retained in the system, or (2) a user that was not retained in the system.

The types of products interacted with may comprise documents read or events attended. The documents read may comprise one or more of online articles, web pages, published papers, interactive documents, and the like. The events attended may comprise one or more of online or in-person webinars, seminars, conferences, summits, symposiums, forum discussions, workshops, and the like.

The cumulative product interaction quality index may be based on, for each user: feature A comprising a total number of months of interaction with the documents; feature B comprising a number of service inquiries made by the user during a predefined time period; and feature C comprising a number of events attended by the user in the predetermined time period.

The cumulative product interaction quality index may be further based on user retention probability. The user retention probability may be modelled using a best fitting logistic regression model comprising: determining weights for each of the features A, B, and C, wherein the weights are obtained by learning a logistic regression model on the Boolean user retention flag giving a linear combination of features A, B and C to model the user retention probability; determining a mean value for each of the features A, B, and C; determining an average contribution score for each of the features A, B, and C, the average contribution score comprising the product of the mean value of the feature A, B, and C with its respective weight obtained from the logistic regression model.

The method may further comprise determining a total interaction quality score for the documents, events, and the service inquiries. The total interaction quality score for the documents may comprise an average number of documents read by the users multiplied by an average interaction quality score for the documents. The interaction quality score of each of the documents consumed by a user may be based on document dwell time and page scroll depth by the user on the respective document. The average interaction quality score for all of the documents may be determined as an average of all the interaction quality scores of all the documents consumed by all the users. The total interaction quality score for the events attended may comprise the total interaction quality score for the documents divided by the average contribution score for feature A, multiplied by the average contribution score for feature C. The total interaction quality score for the service inquires may comprise the total interaction quality score for the documents divided by the average contribution score for feature A, multiplied by the average contribution score for feature B.

The method may further comprise: computing an average interaction quality score for the documents read by dividing the total interaction quality score for the documents by the average number of documents read; computing an average interaction quality score for the service inquires by dividing the total interaction quality score for the service inquires by an average number of service inquires; and computing an average interaction quality score for the events attended by dividing the total interaction quality score for events attended by an average number of events attended. The cumulative product interaction quality index for each user may comprise the sum of: the average interaction quality score for the documents read multiplied by the number of documents read by the user; the average interaction quality score for the service inquires multiplied by the number of service inquires made by the user; and the average interaction quality score for the events attended multiplied by the number of events attended by the user.

The champion peer may comprise the peer connected user having a highest cumulative product interaction quality index and a highest number of types of products that the champion peer interacted with.

The method may further comprise determining whether the product interactions of the querying user are in alignment with each of the one or more user initiatives of the querying user by: determining text vectors comprising a vectorized representation of text of a corresponding one of the one or more user initiatives and a vectorized representation of text of the product corresponding to the product interaction using a natural language processing model, wherein the text of the corresponding user initiative and the text of the product interaction are determined to be in alignment if a cosine similarity between the two text vectors is greater than a predetermined threshold; and ranking the one or more user initiatives of the querying user based on a number of the product interactions that are in alignment with each of the one or more user initiatives, the user initiative having a highest number of aligned product interactions being ranked highest.

A value received by the querying user from the product interactions for the one or more user initiatives may be determined by dividing a number of products the querying user interacted with that are in alignment with the user initiatives of the querying user by a total number of the products the querying user interacted with.

The method may further comprise determining an initiative level product interaction quality score for each of the one or more user initiatives comprising the sum of: the number of the documents read multiplied by the average interaction quality score for the documents; and the number of events attended multiplied by the average interaction quality score for the events.

The product interaction journey may comprise a timeline for the querying user to consume the identified products. The identified products may be presented based on a timeframe of the corresponding product interaction of the champion peer, sorted based on the ranked user initiatives of the querying user.

The timeline of the product interaction journey may provide time periods within which the identified products are to be consumed by the querying user that correspond to a number of days after a contract start date of the champion peer that the identified products were consumed by the champion peer.

A bucket view of the product interaction journey may be provided. The bucket view may comprise a listing of successive time periods, each of the time periods including one or more of the identified products consumed by the champion peer. The time periods may be configurable. For example, the time periods may comprise 90 day time periods. At least one of the time periods may include multiple identified products. In the event the identified products include more than one of the documents, the documents may be sorted for consumption based on an interaction quality score of the champion peer for each of the documents. In the event the identified products include more than one event, the events may be sorted for consumption based on a number of sessions attended by the champion peer in that event.

The product interaction journey may comprise one or more of a schedule, a calendar, a spreadsheet, a document, or the like. The product interaction journey may be one or more of downloadable, printable, emailable, viewable on a computer device or a smartphone, or viewable on a downloadable application or a webpage.

In a further example embodiment of the present invention, a computerized system for providing a champion peer journey recommendation to a querying user is provided. The system may comprise a database comprising a listing of users and corresponding explicit profile information and implicit profile information for each of the users, the explicit profile information comprising information input by or on behalf of the user and the implicit profile information comprising information obtained from the user's product interactions. The system may further comprise a plurality of user interfaces in communication with the database enabling inputting of user information and the product interactions, as well as a computer processor in communication with the user interfaces and the database. The computer processor may be adapted for: determining one or more user initiatives for each user based on at least one of the explicit profile and the implicit profile of the corresponding user; determining peer connections for a querying user from among the users based on comparisons of the explicit profiles, the implicit profiles, and the user initiatives of the users and of the querying user; ranking the users for which peer connections have been determined; determining a champion peer which comprises a peer connected user having a highest ranking; and providing a product interaction journey for the querying user based upon identified products consumed by the champion peer that align with the one or more user initiatives of the querying user, the product interaction journey comprising a timeline for the querying user to consume the identified products.

The system may also include apparatus, features and functionality discussed above in connection with the various method embodiments.

### BRIEF DESCRIPTION OF THE DRAWINGS

The present invention will hereinafter be described in conjunction with the appended drawing figures, wherein like reference numerals denote like elements, and:

FIG. 1 shows a flow diagram of an example embodiment of identifying a champion peer in accordance with the present invention;

FIG. 2 shows a flow diagram of an example embodiment of providing a product interaction journey to a querying user in accordance with the present invention;

FIG. 3 shows a flow diagram of an example embodiment of a value tracking system in accordance with the present invention; and

FIG. 4 shows a peer connection graph in accordance with an example embodiment of the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

Systems, apparatus, and methods for providing a champion peer product interaction journey recommendation to a querying user are provided. Candidate peer users are identified for the querying user using a graph system where all the users in a database are represented on nodes and the edges are formed based on similarities in: i) an explicit profile consisting of profile attributes such as industry type, user job role, country, enterprise size and, user stated initiatives; and in) an implicit profile consisting of information obtained from user-product interactions and user initiatives. An edge is also formed if the similarity between the vectorized representations of user initiatives is greater than a pre-analyzed threshold. In the event there are multiple user initiatives of a user, average vectorized representation of all the initiatives is considered for the user. Pre-analyzed thresholds are determined based on experiments and human expert validation. Weights are assigned to the edges based on the number of total profile matches between the corresponding nodes. Candidate peers are recommended to the querying user by fetching a subgraph consisting of nodes connected directly to the querying user.

A best match from among the candidate peers (referred to herein as a champion peer) for the querying user is identified by sorting the shortlisted candidate peers based on their cumulative quality of all the product interactions and the total number of product types they interacted with. For example, a candidate peer user who has interacted with 2 different types of products (for example, documents and events) is weighed more than candidate peer users who have interacted with only 1 type of product (for example, only documents). The cumulative quality of product interactions by a user is represented as the weighted sum of the number of interactions of each product type. The total number of product interactions aligning with the querying user's initiative are identified for all the candidate peers, and the peers qualifying by the pre-analyzed threshold and the ones which have been retained (or are new users) are selected for sorting. Pre-analyzed thresholds are decided based on experiments and human expert validation.

The cumulative product interaction quality index for any user is represented as the weighted sum of the number of interactions of each product type, where weights for each product type are computed using the following algorithm:
a) A user retention probability prediction model is trained on all the users in the database with a retained Boolean flag (1, if the user was retained, 0 otherwise) as the target variable and considering input feature variables such as: i) the total number of months when the user interacted with documents; ii) the number of service inquiry requests in the last 120 days; and iii) total events and webinars attended in last 120 days.
b) The average contribution of each input feature variable to user retention is represented as the retention probability predicted by the trained model obtained with the mean value of the respective input feature and the other input features being zero.
c) The total interaction quality for the documents is computed by using the average number of documents read by a user and the average quality score for each document interaction obtained using dwell time and page scroll depth.
d) Total interaction quality for the other product types is computed by scaling the total interaction quality of the documents (from step-e) using the average contributions of the product type input feature to the user retention calculated in step-b. For example, for computing the total interaction quality for events, total interaction quality from step-c is scaled with the average contributions of document and event input feature variables.
e) Finally, the total interaction quality (from step-e and d) and the average number of product type interactions by a single user are used to give the average product quality score for each product type which are used as weights for computing the weighted sum for cumulative product quality score for a user.

Value received by the user may be computed by identifying the total number of user-product interactions aligning to the user's initiatives captured from various sources, such as: i) initiatives captured from the user's past behavior (product interactions and email exchanges) algorithmically; and ii) initiatives that are explicitly stated by the user. A higher number of product interactions aligning with the initiatives represents an engaged and highly satisfied user. The product interaction is aligned with the initiatives when a cosine similarity between their vectorized representations surpasses the pre-analyzed threshold where the vector representations are computed using NLP models. This is also used to rank the most valued user initiatives, which is further utilized in sorting the final output of initiative linked product interaction journey. Additionally, as part of the value tracking system, cumulative product interaction quality index is also computed per initiative to track the value.

Product interactions (e.g., documents read and events attended) by the champion peer which align with the querying user's initiatives are identified and sorted based on the quality of interaction. The documents are sorted based on dwell time and document page scroll depth, and the events are sorted based on the number of sessions attended by the champion peer user in that event. These sorted products aligning with the user initiative are then arranged in the different timeline buckets for recommendations, representing the ideal product interactions at different levels of maturity on the querying user's initiative. The querying user can then consume the documents or events previously consumed by the champion peer in the timeline provided. Timeline buckets may be formed from a configurable number of days since the champion peer user's contract start date, for example, bucketing the qualifying product interactions in the first 90 days of the contract and then providing similar buckets for 90-180, 180-270, and 270-360 days.

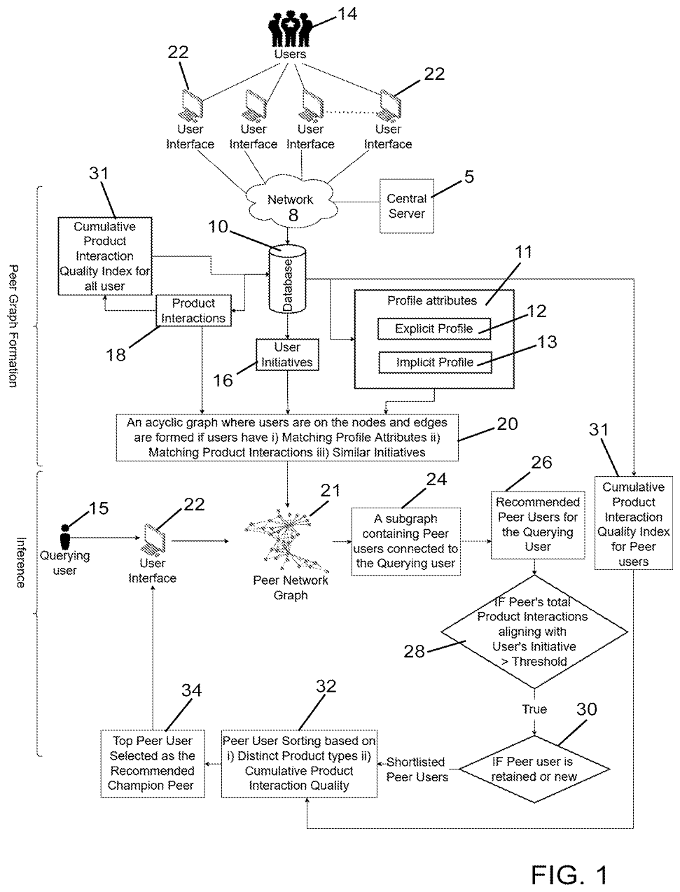

In one example embodiment of the present invention, a computerized method for providing a champion peer journey recommendation to a querying user is provided, as shown in FIG. 1. The method may comprise providing a database 10 comprising a listing of users and corresponding profile attributes 11 (e.g., comprising explicit profile information 12 and implicit profile information 13) for each of the users 14. For new users 14, user info may be entered via a user interface 22 by an associate during an onboarding interview. The user information may also be entered or updated by user themselves.

The explicit profile information 12 may comprise information input by or on behalf of the corresponding user 14 and the implicit profile information 13 may comprise information obtained from the user's product interactions (e.g., documents read, events attended, and the like). The method may further comprise determining one or more user initiatives 16 for each user based on at least one of the explicit profile 12 and the implicit profile 13 of the corresponding user 14. The user initiative may be determined from the user's recent product interaction pattern using recency, frequency and document readership interaction quality. A user initiative 16 may be defined as a user's business program that links to a crucial business issue that the business must execute for the ongoing success of the organization.

A querying user 15 is enabled to access the system via a user interface 22. Peer connections for a querying user 15 can be determined from among the users 14 based on comparisons of the explicit profiles 12, the implicit profiles 13, and the user initiatives 16 of the users 14 and of the querying user 15. The peer connections may be illustrated using a graph system 20 where all the users in the database are represented on a graph 21 where nodes and the edges are formed based on similarities in: i) an explicit profile 12 such as industry type, user job role, country, enterprise size and, user stated initiatives; and it) an implicit profile 13 consisting of information obtained from user-product interactions 18 and user initiatives 16. An edge is also formed if the similarity between the vectorized representations of user initiatives is greater than a pre-analyzed threshold. Pre-analyzed thresholds are determined based on experiments and human expert validation. Weights are assigned to the edges based on the number of total profile matches between the corresponding nodes. Candidate peers are recommended to the querying user by fetching a subgraph 24 consisting of nodes connected directly to the querying user.

The recommended candidate peers 26 (e.g., the users for which peer connections have been determined) can then be sorted and ranked. For example, the candidate peers may be sorted 28 by total product interactions 18 which align with the querying user's initiatives 16 and which are retained users 30 are shortlisted for ranking 32.

A champion peer 34 may then be determined which comprises a peer connected user having a highest ranking 32.

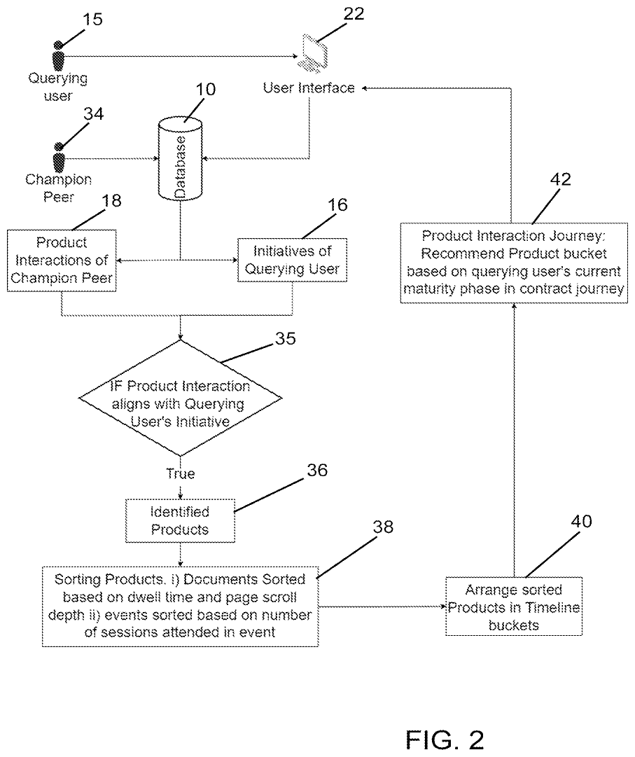

As shown in FIG. 2, a product interaction journey for the querying user 15 may then be provided based upon product interactions 18 of the champion peer 34 that align 35 with the one or more user initiatives 16 of the querying user 15. The resultant identified products 36 are shortlisted and provided to the querying user 15 in the form of a product interaction journey 42. The product interaction journey 42 may comprise a timeline for the querying user to consume the identified products 36. The identified products 36 may include documents or events which can then be sorted 38 for inclusion in the timeline presentation. The documents from among the identified products 36 may be sorted 38 based on dwell time and document page scroll depth. The events may sorted 38 based on the number of sessions attended by the champion peer user in that event.

In one example embodiment, these sorted products aligning with the user initiative are then arranged in the different timeline buckets 40 for recommendations. Each timeline bucket 40 (which may include certain select products or events from the identified products) are then recommended 42 to the querying user 15 for consumption based on the maturity phase in the querying user's contract journey. In particular, the identified products 36 may be presented based on a timeframe of the corresponding product interaction of the champion peer 34, sorted based on the ranked user initiatives of the querying user 15. Further, the timeline of the product interaction journey may provide time periods within which the identified products 36 are to be consumed by the querying user that correspond to a number of days after a contract start date of the champion peer that the identified products 36 were consumed by the champion peer 34.

A bucket view of the product interaction journey may be provided. The bucket view may comprise a listing of successive time periods, each of the time periods including one or more of the identified products 36 consumed by the champion peer. The time periods may configurable. For example, the time periods may comprise 90 day time periods or any other desired period of days, weeks or months. At least one of the time periods may include multiple identified products 36. In the event the identified products 36 include more than one of the documents, the documents may be sorted for consumption based on an interaction quality score of the champion peer for each of the documents. In the event the identified products 36 include more than one event, the events may be sorted for consumption based on a number of sessions attended by the champion peer in that event.

The product interaction journey may comprise one or more of a schedule, a calendar, a spreadsheet, a document, or the like, the product interaction journey may be one or more of downloadable, printable, emailable, viewable on a computer device or a smartphone, or viewable on a downloadable application or a webpage.

The information input by the user 14 forming the explicit profile 12 may comprise at least one of industry type, user job role, country, enterprise size, and the like. The information obtained from the user's product interactions 18 forming the implicit profile 13 may comprise information obtained from documents read by the user 14 and from events attended by the user 14.

The determining of the peer connections for the querying user 15 may comprise determining profile matches between the users 14 and the querying user 15. A profile match may be determined if at least one of the industry type, the user job role, the country, and one or more products consumed of one of the users 14 is the same as that of the querying user 15. A profile match may also be determined if a similarity between vectorized representations of the user initiatives of one of the users and of the querying user is greater than a threshold.

The database 10 may be part of a computerized system that provides access to the products and enables tracking of the product interactions. The user interface 22 may include the necessary processor(s) to carry out the algorithms and associated computations set forth herein. Alternatively, the database 10 and the user interfaces 22 may be in communication with a central server 5 which is enabled to carry out the algorithms and associated computations. The central server 5, the user interfaces 22, and the database 10 may also be in communication with a network 8 (e.g., the Internet, and intranet, and extranet, or the like), enabling users to review online documents and attend online events.

The ranking of the peer users 26 for which peer connections have been determined may be further based on one or more of a number of types of products interacted with 32, a cumulative product interaction quality index 31, a Boolean user retention flag 30, and a Boolean product interaction flag 28 indicating the peer user's total product interactions aligning with the querying user's initiative. The Boolean user retention flag 30 may be based on whether the user was: (1) a new user in the system or a user retained in the system (flag set to “1”), or (2) a user that was not retained in the system (flag set to “0”). Further, the Boolean product interaction flag 28 may be based on whether the number of product interactions of the peer user aligning to querying user's initiative was: (1) greater than or equal to a pre-analyzed threshold (flag set to “1”), or (2) lower than the threshold (flag set to “0”). Only the peer users with both Boolean flags 28 and 30 as “1” are considered for the ranking process. The cumulative product interaction quality index 31 is calculated for each user and stored in the database, and recalculated based on additional product interactions (e.g., either after each new product interaction or periodically). Once candidate peers are determined, the cumulative product interaction quality index 31 for the recommended peers is obtained from the database 10 and used in the rankings.

The types of products interacted with may comprise documents read or events attended. The documents read may comprise one or more of online articles, web pages, published papers, interactive documents, and the like. The events attended may comprise one or more of online or in-person webinars, seminars, conferences, summits, symposiums, forum discussions, workshops, and the like. Events may be in-person events or online events. Online events may be tracked by the system (e.g., when user registers/participates via the user interface 22). Information pertaining to in-person events may be manually entered into the system via a user interface 22 (e.g., either via the user or a supervisor upon completion of the event).

The cumulative product interaction quality index 31 may be based on, for each user 14: feature A comprising a total number of months of interaction with the documents; feature B comprising a number of service inquiries made by the user during a predefined time period; and feature C comprising a number of events attended by the user in the predetermined time period. A service inquiry may be a system inquiry made by the user that relates to documents, events, user initiatives, or other system queries.

The cumulative product interaction quality index 31 may be further based on user retention probability. The user retention probability may be modelled using a best fitting logistic regression model comprising: determining weights for each of the features A, B, and C, wherein the weights are obtained by learning a logistic regression model on the Boolean user retention flag 30 giving a linear combination of features A, B and C to model the user retention probability; determining a mean value for each of the features A, B, and C; determining an average contribution score for each of the features A, B, and C, the average contribution score comprising the product of the mean value of the feature A, B, and C with its respective weight obtained from the logistic regression model. If the weighted sum of features A, B and C (with weights from logistic regression model) is above 0.5, then user retention would be flagged as 1 (retained), if it is less than 0.5, then user retention would be flagged as 0 (not retained).

The method may further comprise determining a total interaction quality score for the documents read, the events, and the service inquiries. The total interaction quality score for the documents may comprise an average number of documents read by the users 14 multiplied by an average interaction quality score for the documents. The interaction quality score of each of the documents consumed by a user may be configurable. For example, the interaction quality score may be based on document dwell time and/or page scroll depth by the user on the respective document. The average interaction quality score for all of the documents may be determined as an average of all the interaction quality scores of all the documents consumed by all the users 14. The total interaction quality score for the events attended may comprise the total interaction quality score for the documents divided by the average contribution score for feature A, multiplied by the average contribution score for feature C. The total interaction quality score for the service inquires may comprise the total interaction quality score for the documents divided by the average contribution score for feature A, multiplied by the average contribution score for feature B.

The method may further comprise: computing an average interaction quality score for the documents read by dividing the total interaction quality score for the documents by the average number of documents read; computing an average interaction quality score for the service inquires by dividing the total interaction quality score for the service inquires by an average number of service inquires; and computing an average interaction quality score for the events attended by dividing the total interaction quality score for events attended by an average number of events attended. The cumulative product interaction quality index for each user may comprise the sum of: the average interaction quality score for the documents read multiplied by the number of documents read by the user; the average interaction quality score for the service inquires multiplied by the number of service inquires made by the user; and the average interaction quality score for the events attended multiplied by the number of events attended by the user.

The champion peer 34 may comprise the peer connected user having a highest cumulative product interaction quality index 31 and a highest number of types of products that the champion peer 34 interacted with.

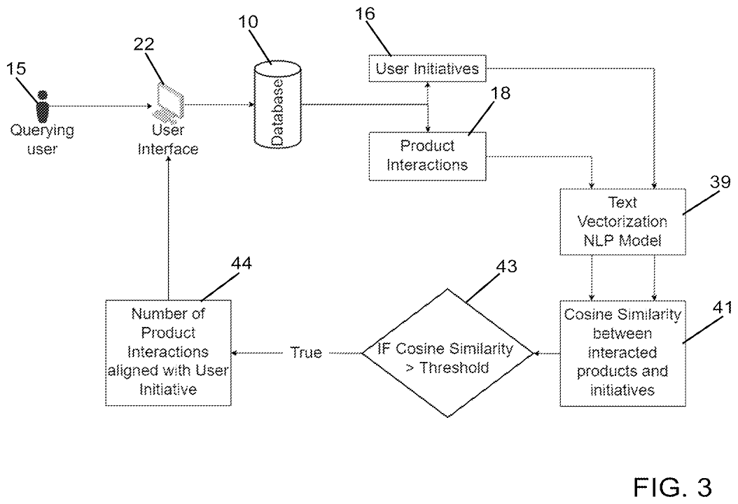

The method may further comprise a value tracking system for determining value received by the user from the product interactions 18. In such an example embodiment as shown in FIG. 3, the method may further comprise determining whether the product interactions 18 of the querying user 15 are in alignment with each of the one or more user initiatives 16 of the querying user by: determining text vectors 39 comprising a vectorized representation of text of a corresponding one of the one or more user initiatives 16 and a vectorized representation of text of the product corresponding to the product interaction using a natural language processing model, wherein the text of the corresponding user initiative 16 and the text of the product interaction are determined to be in alignment if a cosine similarity 41 between the two text vectors is greater than a predetermined threshold 43; and ranking the one or more user initiatives of the querying user 15 based on a number of the product interactions that are in alignment 44 with each of the one or more user initiatives, the user initiative having a highest number of aligned product interactions being ranked highest.

A value received by the querying user 15 from the product interactions 18 for the one or more user initiatives 16 may be determined by dividing a number of products the querying user interacted with that are in alignment with the user initiatives 16 of the querying user 15 by a total number of the products the querying user 15 interacted with.

The method may further comprise determining an initiative level product interaction quality score for each of the one or more user initiatives comprising the sum of: the number of the documents read multiplied by the average interaction quality score for the documents; and the number of events attended multiplied by the average interaction quality score for the events.

In a further example embodiment of the present invention, a computerized system for providing a champion peer journey recommendation to a querying user is provided. The system may comprise a database 10 comprising a listing of users 14 and corresponding explicit profile information 12 and implicit profile information 13 for each of the users 14, the explicit profile information 12 comprising information input by or on behalf of the user 14 and the implicit profile information 13 comprising information obtained from the user's product interactions 18. The system may further comprise a plurality of user interfaces 22 in communication with the database 10 (e.g., via network 8) enabling inputting of user information and the product interactions 18, as well as a computer processor in communication with the user interfaces 22 and the database 10. Those skilled in the art will appreciate that the computer processor may be part of the user interface, part of a central server 5 in communication with the user interface 22, a standalone device, or may be implemented as a combination of such devices. The computer processor may be adapted for: determining one or more user initiatives 16 for each user 14 based on at least one of the explicit profile 12 and the implicit profile 13 of the corresponding user 14; determining peer connections for a querying user 15 from among the users based on comparisons of the explicit profiles 12, the implicit profiles 13, and the user initiatives 16 of the users 14 and of the querying user 15; ranking 32 the users for which peer connections have been determined based on one or more of a similarity of the explicit profiles 12 and a similarity of the implicit profiles 13; determining a champion peer 34 which comprises a peer connected user having a highest ranking; and providing a product interaction journey 42 for the querying user based upon identified products 36 consumed by the champion peer 34 that align with the one or more user initiatives 16 of the querying user 15, the product interaction journey 42 comprising a timeline for the querying user to consume the identified products.

Set forth below is a detailed example of the operation of a champion peer recommendation and value tracking System in accordance with one example embodiment of the present invention:

### Part-1: Peer Recommendation

Step-0: Example User Database (D): List of all users, their explicit profile attributes and past product interactions (documents read and events attended):

TABLE 1

| | | | Job | | | |
|---|---|---|---|---|---|---|
| User | Initiative(s) | Industry | Role | Country | Documents read | Events attended |
| Cq | Cloud Computing with Internet of Things | Ind2 | JR1 | Germany | D1, D2, D3, | E1, E2, E3, |
| (Querying user) | Security of Infrastructure and Data | | | | D8, D9 | E4, E9, E10 |
| C2 | Software Engineering Technologies | Ind3 | JR3 | Canada | D3, D10 | E1, E2, E3 |
| C3 | Supply Chain Strategy | Ind2 | JR2 | Germany | D13, D14 | E8 |
| C4 | IT Strategy | Ind4 | JR1 | Japan | D21 | |
| C5 | Information and Infrastructure security | Ind5 | JR4 | England | D1, D2, D12 | E16, E17, E18, B19 |
| C6 | Cloud Computing and IoT Blockchain development | Ind6 | JR5 | Finland | D8, D9, D15, D16, | E9, E10, E11, E12, |
| | and metaverse | | | | D17, D18, D19, D20 | B13, E14, B15 |
| C7 | Data and Analytics | Ind1 | JR2 | Poland | D11 | E6, E7, E8, E11 |
| C8 | CRM Strategy and Customer Experience | Ind7 | JR6 | Canada | D4, D11 | |
| C9 | Migration to Web3 and blockchain | Ind8 | JR7 | France | D12 | E5 |
| C10 | Trends and Advancements in blockchain technology | Ind1 | JR8 | USA | D4, D5, D6, D7 | E5, E6, E7 |

| | | |
|---|---|---|
| Average Number of Product Interactions by all Clients | 2.9 | 2.9 |

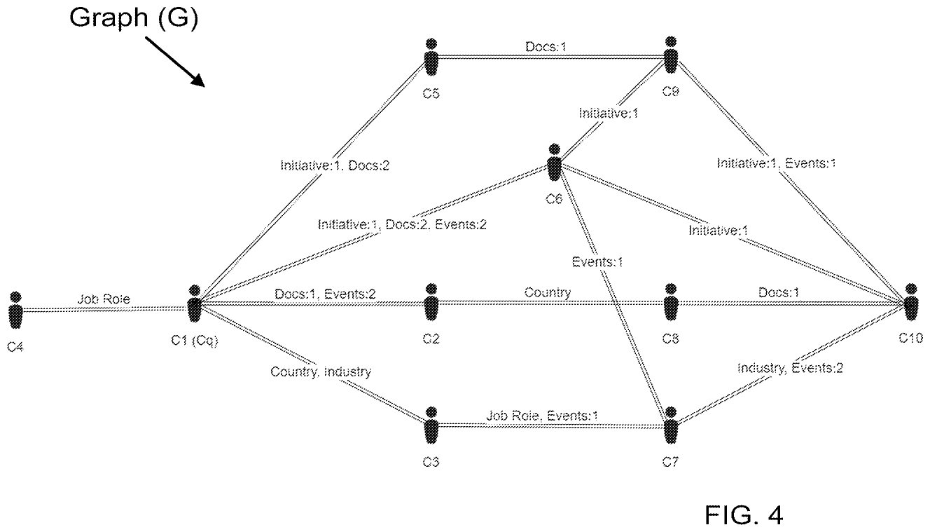

Step 1: Form Peer Connections and Graph (G) based on matching profiles and product interactions, as shown in FIG. 4.

All the users (Ci) are on the nodes of the graph and an edge is created between them if they are identified as peers. The above diagram also indicates the reasons for peer match over the edges. For example, {Initiative: 1, Docs:2, Events:2} represents that the two users had 1 common initiative, read 2 common documents, and attended 2 common events.

Step 2: List Peer Users from Peer graph for Querying user Cq:
Peer Users connected to Cq in Graph G: C2, C3, C4, C5, C6

### Part-2: Champion Peer

Step 3: Get champion peer (Cx) sorting features (calculation of column X is shown in further steps)

TABLE 2

| | Cumulative | Number of | Peer |
|---|---|---|---|
| | Product | Unique | Retention |
| Peer | Interaction | products | Flag |
| User | Quality (X) | (N) | (F) |
| C2 | 26.7 | 2 | 1 |
| C3 | 10.9 | 2 | 0 |
| C4 | 1.5 | 1 | 0 |
| C5 | 32.8 | 1 | 1 |
| C6 | 57.7 | 2 | 1 |

Only the peer users who have renewed their contracts during the current year or have signed up under a new contract for the current year are considered. Column F is 1 if the peer is a new user or has renewed their contract, else it is 0. Hence, from Table 2, users C3 & C4 are not considered for champion peer as they have not been retained. All the eligible peer users are sorted based on Cumulative Product Interaction Quality Index (Column-X from Table-2) and in case of a tie, the number of unique products (Column N from Table 2) is used. The top peer user is selected as the champion peer: C6 is obtained as the champion peer for this example.

### Part-3: Cumulative Product Interaction Quality Index

Cumulative Product Interaction quality index represents the aggregated interaction quality of all the products interacted by a user. This score is used to sort the querying user's peers and identify a top champion peer (as used in Table 2). It is represented as the weighted sum of the number of interactions of each product type where weights for each type of product are computed using the following steps:

Step 4: Calculation of Cumulative product interaction quality index(X) which is stored in the database:

Step 4.1: Extract the following 3 shortlisted Features for every user from Database D

Feature-1 (A): Total Months of Interactions with Documents

Feature-2 (B): Number of service inquiries by the user in last 120 days

Feature-3 (C): Number of events or webinars attended by the user in last 120 days

Target Variable (T) for logistic regression model: 1 if the user was retained, 0 if the user wasn't retained.

TABLE 3

| User | Feature A | Feature B | Feature C | Target-T |
|---|---|---|---|---|
| C1 (Cq) | 4 | 3 | 6 | 1 |
| C2 | 5 | 3 | 3 | 1 |
| C3 | 2 | 1 | 0 | 0 |
| C4 | 2 | 1 | 0 | 0 |
| C5 | 3 | 3 | 4 | 1 |
| C6 | 7 | 5 | 7 | 1 |
| C7 | 1 | 0 | 0 | 0 |
| C8 | 1 | 1 | 0 | 0 |
| C9 | 0 | 0 | 1 | 0 |
| C10 | 5 | 3 | 4 | 1 |
| Feature Mean | 3 | 2 | 2.5 | |
| Feature Sum | 30 | 20 | 25 | |

Step 4.2: Train a logistic regression model on the above 3 features A, B, and C with retention as the target variable. The weights obtained from this model can be used to model the retention probability of the user given the feature set.

The following equation can be obtained:

$$retention\_probabilty = w 1 * A + w 2 * B + w 3 * C \qquad ( equation 1 )$$

where, w1, w2, w3 are the weights obtained from the logistic regression model.

For the Example Database D, weights are:
w1=0.19, w2=0.54, w3=0.69

Step 4.3: Obtain the average contribution of each feature variable to retention probability using the equation 1 from the above step. This is later used to scale the total interaction qualities, since contribution of each feature in equation 1 represents a product's importance for the retention probability of the user.

TABLE 4

| | Formula | | Contribution |
|---|---|---|---|
| | for avg | | of each |
| | contribution | | variable |
| Avg Contribution of | w1*(mean(A)) + | 3*0.19 + 0 + 0 | 0.57 |
| Documents(a): | w2*0 + w3*0 | | |
| Avg Contribution of | w1*0 + | 0 + 2*0.54 + 0 | 1.08 |
| Service Inquiry(b): | w2*(mean(B)) + | | |
| | w3*0 | | |
| Avg Contribution of | w1*0 + w2*0 + | 0 + 0 + 2.5*0.69 | 1.73 |
| Events(c): | w3*(mean(C)) | | |

Step-4.4: Total interaction quality for documents:
Interaction quality for documents is computed directly since the documents' interaction quality can be expressed in terms of measurable and quantifiable factors.

Total interaction quality for documents (TDI) is computed as:

TDI=Average number of documents read by users*(avg quality score for documents using dwell time and page scroll depth)

Avg Quality score for documents (calculated using dwell time and page scroll depth)=1.5 Avg no. of Docs read by a user (from Table 1)=2.9

Hence, TDI=2.9*1.5=4.35

Step 4.5: Total interaction quality for events (TEI) and service inquiries (TSII):
Interaction quality for other interaction types is computed by scaling the total interaction quality of documents using the average contributions of the product features (obtained in step 4.3) to the overall user retention probability.

For Database-D: Using the value of TDI from Step 4.4 and values of a, b, c from Step 4.3:

TABLE 5

| Normalization formula for total | | Final |
|---|---|---|
| interaction quality w.r.t TDI | Calculation | Value |
| Total Interaction Quality for | (4.35/0.57)*1.73 | 13.2 |
| Events (TEI) = (TDI/a)*b | | |
| Total Interaction Quality for | (4.35/0.57)*1.08 | 8.24 |
| Service Inquiries (TSII) = (TDI/a)*c | | |

Step 4.6: Average Interaction Quality for all product types

TABLE 6

| Formula | | Final Value |
|---|---|---|
| Avg Interaction Quality for Document (ADI) = | 4.35/2.9 | 1.5 |
| TDI/Avg no. of documents read by a user | | |
| (from Table-1) | | |
| Avg Interaction Quality for Service Inquiry | 8.24/2.5 | 3.3 |
| ASII = TSIII/Avg no. of service Inquiries | | |
| by a user | | |
| Avg Interaction Quality for Event (AEI) = | 13.2/2.9 | 4.6 |
| TEI/Avg no. of events attended by a user | | |
| (from Table-1) | | |

Step 4.7: Obtain Cumulative Product Interaction Quality Index (X) using ADI, AEI, ASII

Using values from Table-1 and Table-3:

TABLE 7

| | Total | Total | Total | X = ADI*(1) + |
|---|---|---|---|---|
| | Documents | Events | Service | AEI*(2) + |
| User | read (1) | Attended (2) | Inquiries (3) | ASII*(3) |
| C2 | 2 | 3 | 3 | 26.7 |
| C3 | 2 | 1 | 1 | 10.9 |
| C4 | 1 | 0 | 0 | 1.5 |
| C5 | 3 | 4 | 3 | 32.8 |
| C6 | 6 | 7 | 5 | 57.7 |

### Part-4: Initiative Ranking for Querying User Cq

Step 5: Rank the initiatives of the querying user Cq using the number of product interactions aligning with each querying user's initiatives. The same approach is also used to compute and track the value received by the querying user (covered in Part-6).

The alignment of Initiative and product is evaluated by measuring the similarity score between the vectorized representation of both the texts (product and Initiative text) obtained using the NLP model. Both the texts are considered as aligning to each other if the computed similarity score between the two text vectors is greater than the pre-analyzed threshold.

### For Example Database D:

TABLE 8

| | Product interactions of Cq |
|---|---|
| Initiatives of Cq | matching with Initiative |
| Cloud Computing with | D1, D2, D3, E1, E2, E3 |
| Internet of Things | |
| Security of | D3, D8, E4 |
| Infrastructure and Data | |

The user initiatives are ranked based on the number of product interactions aligning with that initiative, representing the order of priority of initiatives for the user. This rank is used in Part to order the final product recommendation output.

### Part-5: Initiative Linked Product Interaction Journey

Step 6: Product Recommendation based on champion peer's Product Interaction Journey

Step 6.2: Among the products which the champion peer (Cx) interacted with, shortlist the ones that align with the querying user's (Cq) initiatives. Then determine the number of days after the contract start date of Cx after which the product interaction happened.

TABLE 9

| | | Days after Contract |
|---|---|---|
| | Aligned | Start date when |
| Shortlisted | Cq's | product interaction |
| Product | Initiative | happened |
| D15 | Cloud Computing with | 54 |
| | Internet of Things | |
| D16 | Cloud Computing with | 140 |
| | Internet of Things | |
| D19 | Security of | 220 |
| | Infrastructure and Data | |
| D18 | Security of | 5 |
| | Infrastructure and Data | |
| E11 | Cloud Computing with | 10 |
| | Internet of Things | |
| E12 | Cloud Computing with | 300 |
| | Internet of Things | |
| E13 | Security of | 95 |
| | Infrastructure and Data | |

Step 7: Generating the Bucket view for product recommendation to Cq based on the amount of time since the start of the contract:

TABLE 10

| | Product | Product | Product | Product |
|---|---|---|---|---|
| | Recom- | Recom- | Recom- | Recom- |
| | mendation | mendation | mendation | mendation |
| | for first 90 | for 90-180 | for 180-270 | for 270-360 |
| | days of | days of | days of | days of |
| Initiative | contract | contract | contract | contract |
| Cloud Computing | D15, E11 | D16 | | E12 |
| with Internet | | | | |
| of Things | | | | |
| Security of | D18 | E13 | D19 | |
| Infrastructure | | | | |
| and Data | | | | |

In final output, the rows are sorted based on the rank of the initiative obtained in Part 4. The bucket size of 90 days is configurable.

Step 8: In case, there are multiple products in the same bucket, then:
1. Sort Documents read by champion peer (Cx, C6) based on the quality score obtained using dwell time and page scroll depth.
2. Sort Events attended by champion peer (Cx) based on the number of sessions attended in that event.

### Part-6: Value Tracking System for Querying User Cq

Step 9: Track and measure the value received by the querying user using the product interactions aligning with each querying user's initiatives (e.g., as in Part 4). Additionally, initiative level cumulative product interaction quality index is also computed for tracking the value received on each initiative. This acts as a quantifiable indicator to measure the impact of the product recommendations made in Part 5.

For example, before making recommendations to the user, the value received by the user by interacting with the products can be computed as:

TABLE 11

| | Product interactions of Cq |
|---|---|
| Initiatives of Cq | matching with Initiative |
| Cloud Computing with | D1, D2, D3, E1, E2, E3 |
| Internet of Things | |
| Security of | D3, D8, E4 |
| Infrastructure and Data | |

Since 8/11 product interacted by the user align to their initiative, hence the total value received by the user on their Initiatives is 8/11=72%

where, 11 is the total number of product interactions by Cq from Table 1, and 8 is the number of product interactions matching with the initiatives (as in Table 8).

Cumulative Product interaction quality index for each Initiative (using the weights obtained in Table 6)

TABLE 12

| | Number of | Number of | |
|---|---|---|---|
| | Documents | Events | X = |
| | matching with | matching with | (1)*(ADI) + |
| Initiatives of Cq | Initiative(1) | Initiative(2) | (2)*(AEI) |
| Cloud Computing | 3 | 3 | 18.3 |
| with Internet | | | |
| of Things | | | |
| Security of | 2 | 1 | 7.6 |
| Infrastructure | | | |
| and Data | | | |

Similarly, the total value received can be tracked after making the relevant recommendations from Table 10.

It should now be appreciated that the present invention provides advantageous systems, methods and apparatus for providing a champion peer journey recommendation to a querying user, including a value tracking function to determine value received by the querying user.

Although the invention has been described in connection with various illustrated embodiments, numerous modifications and adaptations may be made thereto without departing from the spirit and scope of the invention as set forth in the claims.

What is claimed is:

1. A computerized method for providing a champion peer journey recommendation to a querying user, comprising:
providing a database comprising a listing of users and corresponding explicit profile information and implicit profile information for each of the users, the explicit profile information comprising information input by or on behalf of the user and the implicit profile information comprising information obtained from the user's product interactions;
determining one or more user initiatives for each user based on at least one of the explicit profile and the implicit profile of the corresponding user;
determining peer connections for a querying user from among the users based on comparisons of the explicit profiles, the implicit profiles, and the user initiatives of the users and of the querying user;
ranking the users for which peer connections have been determined;
determining a champion peer which comprises a peer connected user having a highest ranking;
providing a product interaction journey for the querying user based upon identified products consumed by the champion peer that align with the one or more user initiatives of the querying user, the product interaction journey comprising a timeline for the querying user to consume the identified products.

2. The method in accordance with claim 1, wherein:
the information input by the user forming the explicit profile comprises at least one of industry type, user job role, country, and enterprise size; and
the information obtained from the user's product interactions forming the implicit profile comprises information obtained from documents read by the user and from events attended by the user.

3. The method in accordance with claim 2, wherein:
the determining of the peer connections for the querying user comprises determining profile matches between the users and the querying user:
a profile match is determined if: at least one of the industry type, the user job role, the country, and one or more products consumed of one of the users is the same as that of the querying user; or a similarity between vectorized representations of the user initiatives of one of the users and of the querying user is greater than a threshold.

4. The method in accordance with claim 1, wherein the database is part of a computerized system that provides access to the products and enables tracking of the product interactions.

5. The method in accordance with claim 1, wherein the ranking the users for which peer connections have been determined is based on one or more of a number of types of products interacted with, a cumulative product interaction quality index, a Boolean user retention flag, and a Boolean product interaction flag indicating whether a peer's total product interactions align with the querying user's initiative.

6. The method in accordance with claim 5, wherein the Boolean user retention flag is based on whether the user was: (1) a new user in the system or a user retained in the system, or (2) a user that was not retained in the system.

7. The method in accordance with claim 5, wherein:
the types of products interacted with comprise documents read or events attended;
the documents read comprise one or more of online articles, web pages, published papers, and interactive documents; and
the events attended comprise one or more of online or in-person webinars, seminars, conferences, summits, symposiums, forum discussions, and workshops.

8. The method in accordance with claim 7, wherein the cumulative product interaction quality index is based on, for each user:
feature A comprising a total number of months of interaction with the documents;
feature B comprising a number of service inquiries made by the user during a predefined time period; and
feature C comprising a number of events attended by the user in the predetermined time period.

9. The method in accordance with claim 8, wherein the cumulative product interaction quality index is further based on user retention probability, the user retention probability being modelled using a best fitting logistic regression model comprising:
determining weights for each of the features A, B, and C, wherein the weights are obtained by learning a logistic regression model on the Boolean user retention flag giving a linear combination of features A, B and C to model the user retention probability;
determining a mean value for each of the features A, B, and C;
determining an average contribution score for each of the features A, B, and C, the average contribution score comprising the product of the mean value of the feature A, B, and C with its respective weight obtained from the logistic regression model.

10. The method in accordance with claim 9, further comprising determining a total interaction quality score for the documents read, the events, and the service inquiries, wherein:
the total interaction quality score for the documents comprises an average number of documents read by the users multiplied by an average interaction quality score for the documents;
the interaction quality score of each of the documents consumed by a user is based on document dwell time and page scroll depth by the user on the respective document;
the average interaction quality score for all of the documents is determined as an average of all the interaction quality scores of all the documents consumed by all the users;
the total interaction quality score for the events attended comprises the total interaction quality score for the documents divided by the average contribution score for feature A, multiplied by the average contribution score for feature C; and
the total interaction quality score for the service inquires comprises the total interaction quality score for the documents divided by the average contribution score for feature A, multiplied by the average contribution score for feature B.

11. The method in accordance with claim 10, further comprising:
computing an average interaction quality score for the documents read by dividing the total interaction quality score for the documents by the average number of documents read;
computing an average interaction quality score for the service inquires by dividing the total interaction quality score for the service inquires by an average number of service inquires; and
computing an average interaction quality score for the events attended by dividing the total interaction quality score for events attended by an average number of events attended;
wherein the cumulative product interaction quality index for each user comprises the sum of:
the average interaction quality score for the documents read multiplied by the number of documents read by the user;
the average interaction quality score for the service inquires multiplied by the number of service inquires made by the user; and
the average interaction quality score for the events attended multiplied by the number of events attended by the user.

12. The method in accordance with claim 11, wherein the champion peer comprises the peer connected user having a highest cumulative product interaction quality index and a highest number of types of products that the champion peer interacted with.

13. The method in accordance with claim 1, further comprising:
determining whether the product interactions of the querying user are in alignment with each of the one or more user initiatives of the querying user by:
determining text vectors comprising a vectorized representation of text of a corresponding one of the one or more user initiatives and a vectorized representation of text of the product corresponding to the product interaction using a natural language processing model;
wherein the text of the corresponding user initiative and the text of the product interaction are determined to be in alignment if a cosine similarity between the two text vectors is greater than a predetermined threshold; and
ranking the one or more user initiatives of the querying user based on a number of the product interactions that are in alignment with each of the one or more user initiatives, the user initiative having a highest number of aligned product interactions being ranked highest.

14. The method in accordance with claim 13, further comprising:
determining a value received by the querying user from the product interactions for the one or more user initiatives by dividing a number of products the querying user interacted with that are in alignment with the user initiatives of the querying user by a total number of the products the querying user interacted with.

15. The method in accordance with claim 14, further comprising determining an initiative level product interaction quality score for each of the one or more user initiatives comprising the sum of:
the number of the documents read multiplied by the average interaction quality score for the documents; and
the number of events attended multiplied by the average interaction quality score for the events.

16. The method in accordance with claim 13, wherein:
the product interaction journey comprises a timeline for the querying user to consume the identified products;
the identified products are presented based on a timeframe of the corresponding product interaction of the champion peer, sorted based on the ranked user initiatives of the querying user.

17. The method in accordance with claim 1, wherein the timeline of the product interaction journey provides time periods within which the identified products are to be consumed by the querying user that correspond to a number of days after a contract start date of the champion peer that the identified products were consumed by the champion peer.

18. The method in accordance with claim 17, further comprising providing a bucket view of the product interaction journey, the bucket view comprising a listing of successive time periods, each of the time periods including one or more of the identified products consumed by the champion peer.

19. The method in accordance with claim 17, wherein the time periods comprise 90 day time periods.

20. The method in accordance with claim 17, wherein:
at least one of the time periods includes multiple identified products;
in the event the identified products include more than one of the documents, the documents are sorted for consumption based on an interaction quality score of the champion peer for each of the documents;
in the event the identified products include more than one event, the events are sorted for consumption based on a number of sessions attended by the champion peer in that event.

21. The method in accordance with claim 1, wherein:
the product interaction journey comprises one or more of a schedule, a calendar, a spreadsheet, a document; and
the product interaction journey is one or more of downloadable, printable, emailable, viewable on a computer device or a smartphone, or viewable on a downloadable application or a webpage.

22. A computerized system for providing a champion peer journey recommendation to a querying user, comprising:
a database comprising a listing of users and corresponding explicit profile information and implicit profile information for each of the users, the explicit profile information comprising information input by or on behalf of the user and the implicit profile information comprising information obtained from the user's product interactions;
a plurality of user interfaces in communication with the database enabling inputting of user information and the product interactions;
a computer processor in communication with the user interfaces and the database for:
determining one or more user initiatives for each user based on at least one of the explicit profile and the implicit profile of the corresponding user;
determining peer connections for a querying user from among the users based on comparisons of the explicit profiles, the implicit profiles, and the user initiatives of the users and of the querying user;
ranking the users for which peer connections have been determined;
determining a champion peer which comprises a peer connected user having a highest ranking; and
providing a product interaction journey for the querying user based upon identified products consumed by the champion peer that align with the one or more user initiatives of the querying user, the product interaction journey comprising a timeline for the querying user to consume the identified products.
